(19) United States
(12) Patent Application Publication
(10) Pub. No.: US 2010/0282332 A1
(43) Pub. Date: Nov. 11, 2010

(54) High-Pressure Fluid Safety Valve

(75) Inventors: Arnaud Grandjean, Fribourg (CH); Daniel Walser, Fribourg (DE)

Correspondence Address: COHEN, PONTANI, LIEBERMAN & PAVANE LLP, 551 FIFTH AVENUE, SUITE 1210, NEW YORK, NY, 10176, US

(73) Assignees: SOCIETE DETECHNOLOGIE MICHELIN, CLERMONT-FERRAND (FR); MICHELIN RECHERCHE ET TECHNIQUE S.A., GRANGES-PACCOT (CH)

(21) Appl. No.: 12/669,745

(22) PCT Filed: Jul. 9, 2008
(86) PCT No.: PCT/EP2008/058925

§ 371 Date: Jul. 12, 2010

(30) Foreign Application Priority Data
Jul. 16, 2007 (FR) 07/05168

(51) Int. Cl. F16K 17/38; F16K 17/04

(52) U.S. Cl. 137/80; 137/535

(57) ABSTRACT

A safety valve for a fluid circuit under pressure (P), the valve comprising a body (2), a piston (3) able to move with respect to the body between a closed position and a purge position. A thermally deformable element (5) acts to cause the piston to move from the closed position to the purge position above and beyond a purge temperature so as to connect the circuit to a discharge duct (16). The valve further comprises an overpressure relief device sensitive to the pressure of the fluid and configured to connect the circuit to the discharge duct when the pressure (P) of the circuit reaches a trip pressure.

The present invention relates to the storage of fluids under high pressure. It is applicable notably but not solely to the storage of gaseous hydrogen and/or the storage of gaseous oxygen in a road vehicle, for example a vehicle fitted with a fuel cell.

In this field, the pressure at which the gas is stored is commonly 300 bar. Patent application EP 1 591 704 describes such a vehicle and its safety purge system. This system allows the pressurized gas tanks to be purged in the event of a fire or if there is an abnormal increase in the internal pressure of the tanks, using several safety valves some of which are sensitive to a rise in temperature under the vehicle and others of which are sensitive to an internal gas overpressure. All the valves open into a purge circuit organized within a double floor specific to the vehicle, the hydrogen released then being guided towards a discharge orifice situated at the top rear of the vehicle. In said document EP 1 591 704 safety against the risks of the vehicle tanks exploding is therefore provided by combined operation of several different valves.

It is one objective of the invention to provide a level of safety that is at least equivalent but for an appreciably lower cost.

It is another objective of the invention to make the vehicle easier to design and assemble and to maintain.

The invention proposes a safety valve for a fluid circuit under high pressure, the said valve comprising a body, a piston able to move with respect to the body between a closed position and a purge position, a thermally deformable element acting to cause the piston to move from the closed position to the purge position above and beyond a purge temperature so as to connect the circuit to a discharge duct, the piston being pressed against a seat of the body by the pressure of the fluid, the thermally deformable element acting against the pressure of the fluid to lift the piston off the seat, from the closed position to the purge position, the valve further comprising an overpressure relief device sensitive to the pressure of the fluid and configured to connect the circuit to the discharge duct when the pressure of the circuit reaches a trip pressure.

The thermally deformable element is preferably a shape memory pellet.

For preference, the overpressure relief device consists of a diaphragm configured to yield at the trip pressure in order to open an overpressure passage towards the discharge duct.

For preference, the piston is secured to a stem subject to the action of the thermally deformable element.

Again for preference, the diaphragm is situated on the piston, the overpressure passage comprising a bore made in the stem of the piston.

According to a first alternative form, the overpressure passage comprises a blind bore made in the stem, the diaphragm being formed by a skin one face of which corresponds to the end wall of the bore, the other face of the diaphragm corresponding to that surface of the piston that is subject to the pressure of the fluid.

According to a second alternative form, the diaphragm consists of a part attached to the piston.

For preference, the discharge duct comprises a banjo connection held tightly between a first shoulder of the body and a clamping ring screwed onto the body. Alternatively, with the body being of one piece and able to be screwed onto the circuit, the banjo connection is held tightly between the circuit and a second shoulder of the body.

For preference, the piston is also pressed firmly against the seat by the action of a spring. Again for preference, the spring acts between the body and the stem of the piston.

For preference, the body, the piston, the seat, the stem of the piston and the diaphragm all have an overall shape exhibiting symmetry of revolution about a common axis.

Other features and advantages of the invention will become apparent from the description of some preferred embodiments. The figures respectively depict:

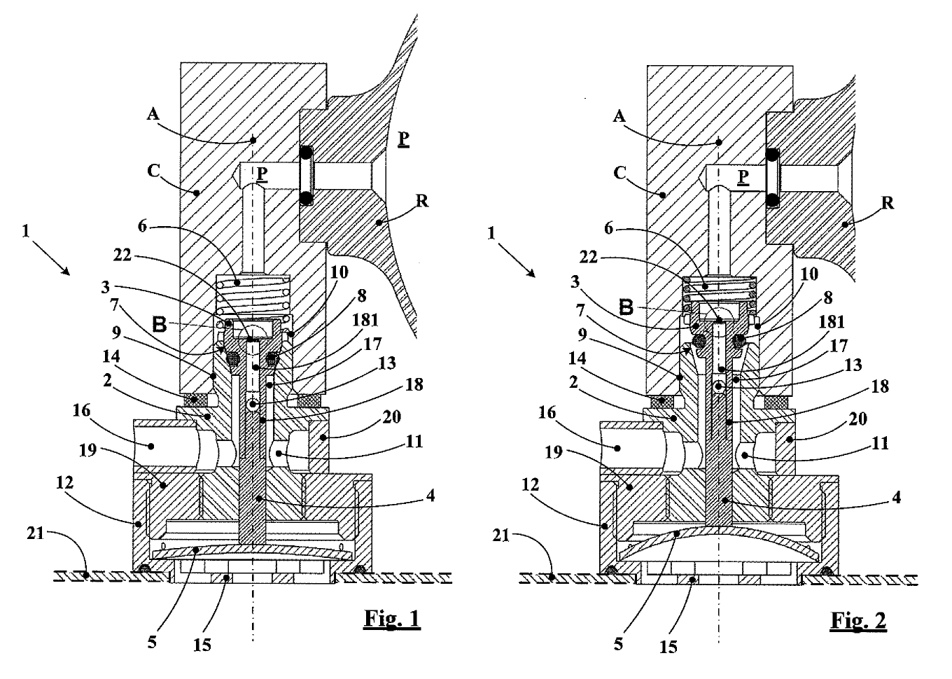

FIG. 1: an axial cross section through a valve according to a first embodiment of the invention;

FIG. 2: an axial cross section through the valve of FIG. 1, with the piston in the open position;

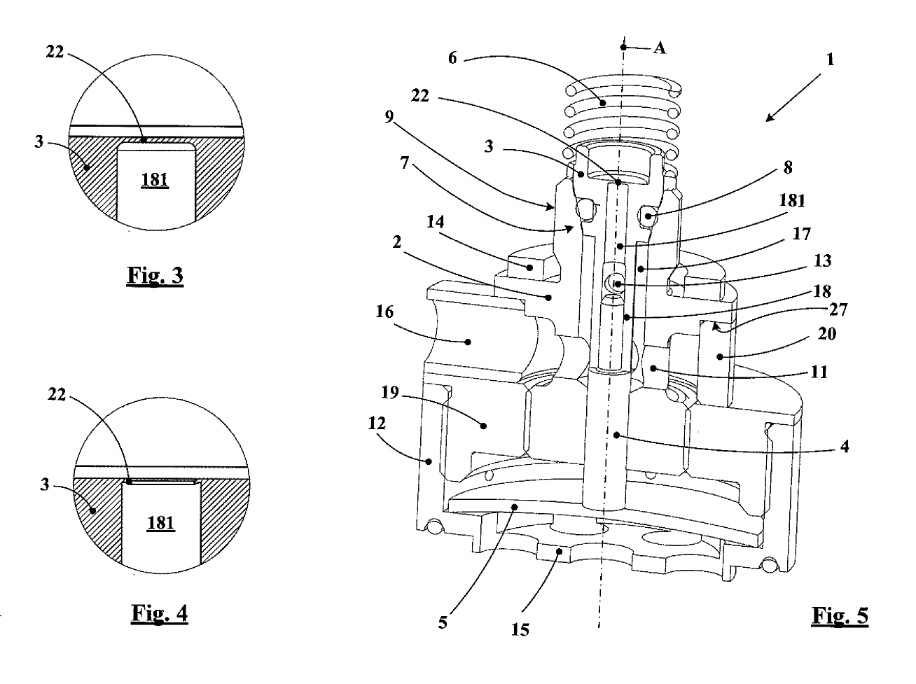

FIG. 3: an axial cross section on a larger scale of the upper part of the piston of the valve of FIG. 1 (detail B);

FIG. 4: a view similar to FIG. 3 showing the diaphragm of the valve of FIG. 1 following an internal overpressure;

FIG. 5: a perspective view in axial part section of the valve of FIG. 1;

FIG. 6: an axial cross section through a valve according to a second embodiment of the invention;

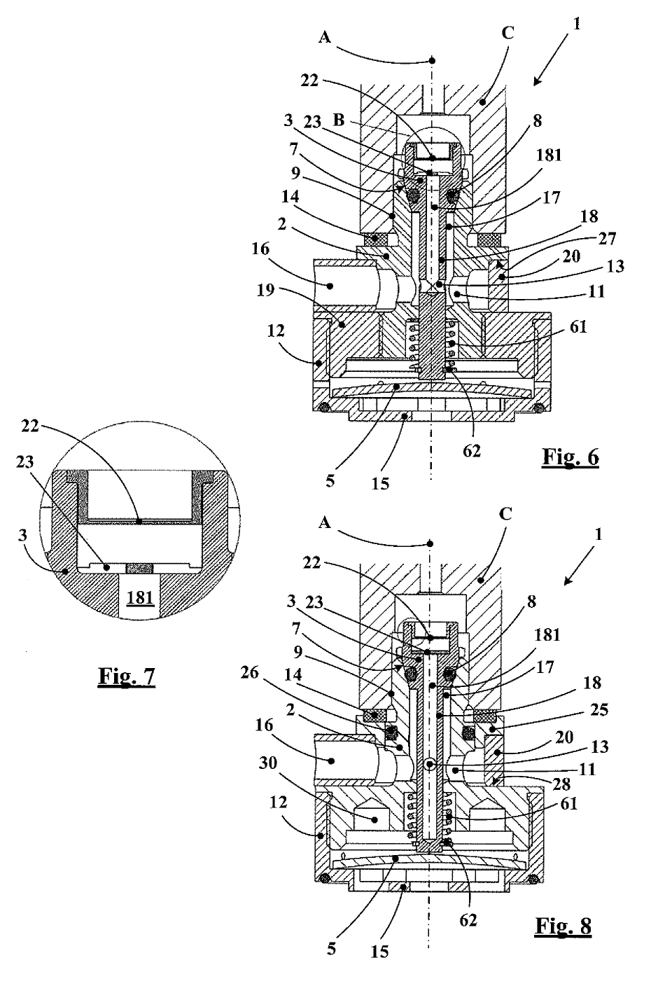

FIG. 7: a larger scale view of detail B of FIG. 6, showing the attached diaphragm;

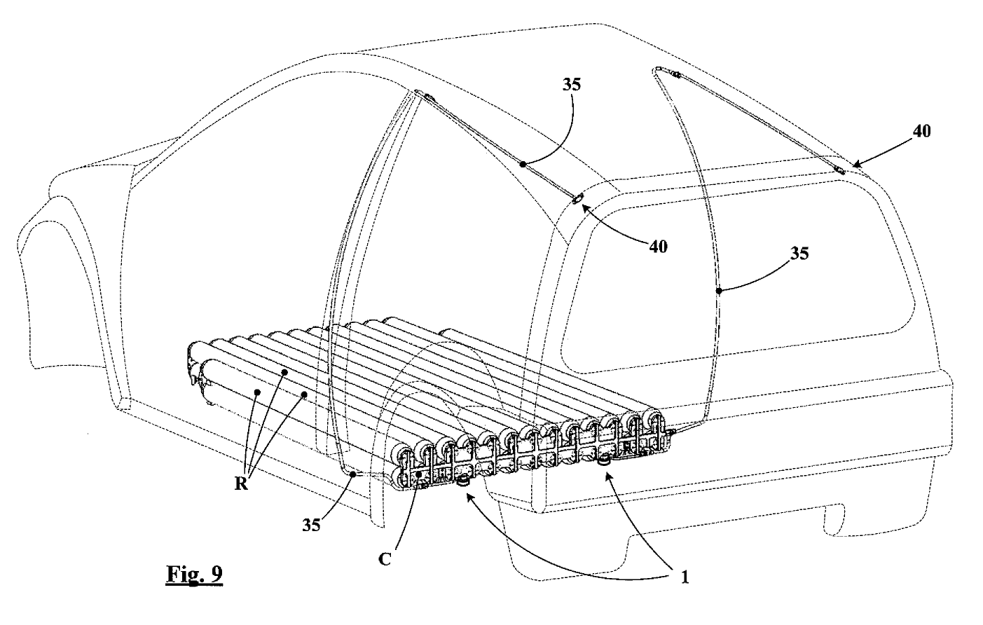

FIG. 8: an axial cross section of a valve according to a third embodiment of the invention;

FIG. 9: a three-quarters rear schematic view of a vehicle equipped with safety valves according to the invention.

In the various figures, elements which are identical or similar bear identical references and are not systematically redescribed.

Reference is made to FIG. 1 which is an axial cross section through a safety valve 1 connected to a circuit C for storing gas under pressure. The circuit connects the valve to one, or preferably a number of, tanks R. The valve 1 could naturally be connected directly to the tank. The body 2 of the valve is a part exhibiting symmetry of revolution about an axis A and also comprises drillings and screw threads. At its end connected to the circuit C, the body of the valve has a screw thread 9 able to collaborate with a threaded housing 10 of the circuit. Along its axis A, the body has a seat 7 with a conical bearing surface designed to accommodate a piston 3, which is likewise conical. The piston is able to move axially with respect to the body of the valve between a closed position and a purge position (clearly visible by comparing FIGS. 1 and 2). An O-ring seal 8 ensures perfect sealing of the piston on the conical seat in the closed position. The piston is pressed firmly against the seat by the pressure of the gas. A preload spring 6, bearing against a shoulder of the housing 10, acts on the piston in the same direction as the pressure of the gas, that is to say that the spring tends also to hold the valve in the closed position. At its other end, the end intended to be subjected to the variations in temperature, the valve comprises a thermally deformable element, in this instance a shape memory pellet 5, which causes the valve to open through the agency of a pushrod 4 acting on the stem 18 of the piston. The pellet 5 is sensitive to the ambient temperature as explained in document EP 1 591 704, that is to say that when its temperature crosses a given purge value (for example 80° C.), the pellet adopts a more domed shape, causing the piston 3 to lift off its seat 7, as may be seen in FIG. 2. As described above, this opening movement is effected against the force produced by the internal pressure of the tank, for example 300 bar. This deformation of the pellet is stable, that is to say irreversible (at least thermally). In its purge position, the piston relieves the gas pressure via the purge duct 17 (situated around the stem 18) to a discharge duct 16. A radial drilling 11 in the body 2 connects the purge duct to the discharge duct 16.

This operation allows the valve to provide explosion protection with regard to an increase in temperature beyond a purge temperature, for example as a result of a fire under or near the vehicle.

The valve according to the invention also provides overpressure protection with regard to an overpressure internal to the circuit, this moreover being irrespective of the origin of this overpressure. To do that, the stem 18 of the piston 3 is hollow and a diaphragm 22 is formed at the surface of the piston. As can be seen best in FIG. 3 which shows this part of the piston in detail, the diaphragm here is a skin of which one face (the bottom face in the figures) corresponds to the end wall of the bore 181 made in the stem and the other face (the top face in the figures) corresponds to the horizontal surface of the piston, the surface permanently subjected to the pressure of the gas. When the internal pressure (P) of the circuit reaches a critical value (hereinafter referred to as the “trip pressure”), the diaphragm 22 definitively yields, becomes detached (as depicted in FIG. 4) or tears to release gas into the stem 18 and through a radial drilling 13 connecting the inside of the stem to the purge duct 17. This overpressure relief device is commonly known even in some other languages by its English name of “burst disc” or “rupture disc”. For example, in the case of a piston made of stainless steel with a rupture strength of the order of 550 MPa, a diaphragm 0.05 mm thick and 2 mm in diameter defines a trip pressure of the order of 350 bar. FIG. 4 shows the scenario whereby the diaphragm has become completely detached, but it may be preferable for the diaphragm to remain partially attached to the piston.

FIG. 5 is a perspective cross-sectional view of the valve of FIGS. 1 to 4 (in the closed position of FIG. 1). This view clearly shows that the discharge duct 16 is connected to the valve by a connector 20, commonly known as a “banjo connector”. The benefit here of using a banjo connector 20 is that the discharge duct 16 can be oriented at will with respect to the body 2 of the valve. Thus, once the body of the valve has been screwed into the circuit and the flat gasket 14 has been clamped so that it seals, the banjo connector is positioned in the desired orientation for the discharge duct 16. The banjo in its turn is tightened against the body, specifically against a first shoulder 27 of the body, by the clamping ring 19. The ring 19 is screwed onto a screw thread surrounding the lower part of the body of the valve. The discharge duct 16 is then led away to a chosen place to which the gas will be vented, for example to the top rear of the vehicle as proposed in application EP 1 591 704 (refer to FIG. 1 of that document). Use may be made of a two-outlet banjo so that several valves can be interconnected along one and the same discharge duct 16.

A base 12, screwed in its turn under the ring 19, holds the shape memory pellet 5 in position and preferably has a lower wall 15 that is perforated so that the ambient temperature under the floor 21 (depicted in dotted line in FIGS. 1 and 2) of the vehicle is transmitted rapidly to the pellet.

As may be seen clearly in these figures, the fact that the pushrod 4 is a part attached with respect to the stem 18 allows the bore 181, and therefore the diaphragm 22, to be created for example by removal of material or by forging. It will be appreciated that other techniques for obtaining the bore 181 and the drilling 13 (for example using lost-pattern casting) may lead to a structure that differs for an equivalent function.

FIG. 6 depicts a second embodiment of the safety valve of the invention. It differs from the first embodiment (FIGS. 1 to 5) in that the diaphragm 22 is attached to the piston 3 and not formed directly in the upper surface thereof. The way in which the overpressure relief device works is the same as in the first embodiment but because the diaphragm has a larger surface area, its thickness may also be greater, making it easier to obtain. In addition, because the diaphragm is attached, the bore 181 inside the stem 18 can open onto the top of the stem rather than the bottom, making it possible to dispense with a closure element such as the pushrod 4 of the first embodiment. This second embodiment also differs from the first embodiment in that the preloading spring 61 is placed at the bottom of the valve. It acts between the body 2 and a stop element (a circlip 62) secured to the stem of the piston. This makes it possible, amongst other things, for the valve to be removed from the circuit c without the spring having a tendency to eject it. Quite the contrary, the body, the spring and the piston remain joined together without the risk of any one or other part becoming lost or damaged during this disassembly. In addition, the valve can be connected to a wider range of circuits or tanks (different shapes or materials) because there is no longer any need for the connection to provide a shoulder against which the spring can bear as in the previous embodiments.

FIG. 7 depicts detail B of FIG. 6 on a larger scale. It shows the diaphragm 22 attached to the piston 3. It also shows a grating 23 positioned in such a way as to hold back pieces which may (if the trip pressure is exceeded) become detached from the diaphragm and obstruct the passage of gas to the inside 181 of the stem of the piston. The attached diaphragm 22 is preferably fixed to the piston in a fluidtight manner (for example by electron beam welding).

FIG. 8 depicts a third embodiment of the invention. This embodiment repeats the specific features of the second embodiment (FIG. 6), that is to say the principles of the attached diaphragm and of the spring situated at the lower part of the valve. The embodiment of

FIG. 8 further differs from the first two embodiments in that the body 2 does not bear against the seal 14 directly but only via a stepped collar 25. This annular collar is able to slide along the body 2, allowing the body of the valve to be extracted axially without the need to move the banjo 20. Because the valve can now be extracted from the housing 10, from the seal 14 and from the banjo 20 in the same direction (downwards in the figure), the bottom part of the valve can also be made as one piece rather than as two parts screwed together (see body 2 and ring 19 in FIG. 6). The banjo 20 is now held tightly by a second shoulder (28) of the body of the valve. The valve can be clamped onto the circuit using a pin wrench (see recesses 30 in the body). An O-ring seal 26 provides sealing between the collar 25 and the body 2.

FIG. 8 shows a stepped collar 25 independent of the banjo 20. However, it will be appreciated that the functions of centring and sealing of the collar 25 may be adopted by a specially adapted banjo, thus rendering said collar superfluous.

In all of the figures, the connection between the base 12 and the body 2 or the ring 19 is depicted as a threaded connection. Some other type of connection (for example a bayonet fitting) may make for speedier access to the shape memory pellet 5.

FIG. 9 (partially) shows a vehicle equipped with the safety valve according to the invention. This example clearly shows the numerous tanks R, connected to one another and to two safety valves 1 by a circuit C. The discharge ducts are connected to the outside by pipes 35 running through the bodywork towards discharge orifices 40 situated at the top rear of the vehicle. It will be appreciated that just one valve according to the invention and one single pipe may suffice. Providing that two valves and two independent discharges on one and the same circuit does, however, extend the sensitivity to external temperature and also create redundancy which further promotes safety. Indeed, if one of the pipes is obstructed, the circuit can still be discharged using the other. In addition, if (as mentioned above), the discharge ducts from the two valves are connected to one another by a pipe (not depicted here), the left-side valve will be able to discharge through the right-side pipe, and vice versa.

The parts that make up the safety valve according to the invention in the majority of cases have an overall shape exhibiting symmetry of revolution. Hence, producing each part and assembling the parts are relatively simple and therefore inexpensive procedures.

The safety valve according to the invention has just been described with reference to use in a vehicle, but of course it may be used in other gas storage and also liquid storage circuits, for example in stationary storage plants or conversion or production units. In particular, the fact that its shape exhibits symmetry of revolution and that its discharge duct can be oriented at will allows the valve to be installed in any position and any orientation whatsoever.

The thermally deformable element (5) may also, rather than directly lifting the piston off its seat, cause the piston to move indirectly from the closed position to the purge position, for example by releasing the action of a spring by undoing a latch.

In the configurations illustrated here, following a purge of thermal origin, all that is required is for the pellet to be replaced or even for the pellet to be returned mechanically to its original form in order for the valve to become operational once again. However, in certain specific applications it may be desirable for safety reasons for the circuit to be definitively disabled following a purge of thermal origin. To do that, provision may be made for the opening movement of the piston to move the diaphragm towards a spike which definitively tears it, in which case a return to normal thermal conditions and replacement of the pellet will no longer be enough to allow the circuit to be repressurized.

1. A safety valve for a fluid circuit under high pressure, the valve comprising a body, a piston able to move with respect to the body between a closed position and a purge position, a thermally deformable element acting to cause the piston to move from the closed position to the purge position above and beyond a purge temperature so as to connect the circuit to a discharge duct, the piston being pressed against a seat of the body by the pressure of the fluid, the thermally deformable element acting against the pressure of the fluid to lift the piston off the seat, from the closed position to the purge position, the valve further comprising an overpressure relief device sensitive to the pressure of the fluid and configured to connect the circuit to the discharge duct when the pressure of the circuit reaches a trip pressure.

2. The safety valve according to claim 1, wherein the thermally deformable element is a shape memory pellet.

3. The safety valve according to claim 1, wherein the overpressure relief device consists of a diaphragm configured to yield at the trip pressure in order to open an overpressure passage towards the discharge duct.

4. The safety valve according to claim 1, wherein the piston is secured to a stem subject to the action of the thermally deformable element.

5. The safety valve according to claims 3 wherein the piston is secured to a stem subject to the action of the thermally deformable element, and the diaphragm is situated on the piston, the overpressure passage comprising a bore made in the stem of the piston.

6. The safety valve according to claim 4, wherein the overpressure passage comprises a blind bore made in the stem, the diaphragm being formed by a skin one face of which corresponds to the end wall of the bore, the other face of the diaphragm corresponding to that surface of the piston that is subject to the pressure of the fluid.

7. The safety valve according to claim 3, wherein the diaphragm comprises a part attached to the piston.

8. The safety valve according to claim 1, wherein the discharge duct comprises a banjo connection held tightly between a first shoulder of the body and a clamping ring screwed onto the body.

9. The safety valve according to claim 1, wherein the discharge duct comprises a banjo connection, the body being of one piece and able to be screwed onto the circuit, the banjo connection being held tightly between the circuit and a second shoulder of the body.

10. The safety valve according to claim 4, wherein the piston is also pressed firmly against the seat by the action of a spring.

11. The safety valve according to claim 10, wherein the spring acts between the body and the stem of the piston.

12. The safety valve according to claim 5, wherein the body, the piston, the seat, the stem of the piston and the diaphragm all have an overall shape exhibiting symmetry of revolution about a common axis.

13. The safety valve according to claim 1, wherein the bearing surfaces of the piston and of the seat are conical bearing surfaces.
